(19) United States
(12) Patent Application Publication
(10) Pub. No.: US 2026/0339173 A1
(43) Pub. Date: Oct. 29, 2026

(54) ACCESSORY MOUNT AND ACCESSORY APPARATUS

(71) Applicant: CANON KABUSHIKI KAISHA, Tokyo (JP)

(72) Inventor: KATSUMI OHMORI, Tochigi (JP)

(21) Appl. No.: 19/567,466

(22) Filed: Mar. 16, 2026

(30) Foreign Application Priority Data
Apr. 25, 2025 (JP) 2025-072941

(51) Int. Cl. G03B 17/14; G02B 7/02; G02B 7/14

(52) U.S. Cl. CPC G03B 17/14; G02B 7/022; G02B 7/026; G02B 7/14

(57) ABSTRACT

An accessory mount is attachable to and detachable from a camera mount. The accessory mount includes a base portion, and a movable portion movable relative to the base portion. When the accessory mount is attached to the camera mount, the movable portion moves to a first side by coming into contact with a part of the camera mount, and then moves to a second side opposite to the first side, thereby overlapping the part when viewed from a central-axis direction of the accessory mount.

### BACKGROUND

### Field of the Technology

The present disclosure relates to an accessory mount attachable to and detachable from a camera mount, and an accessory apparatus, such as a lens apparatus.

### Description of the Related Art

Japanese Patent Applications Laid-Open Nos. 8-43910 and 2017-138437 disclose an accessory apparatus having an accessory mount that is attachable to and detachable from a camera mount. The accessory apparatus is attached to the camera mount by inserting the accessory mount into the camera mount in an insertion phase (insertion orientation or insertion rotational position) and then rotating the accessory mount.

### SUMMARY

An accessory mount may be attachable to and detachable from a camera mount. The accessory mount may include a base portion, and a movable portion movable relative to the base portion. When the accessory mount is attached to the camera mount, the movable portion may move to a first side by coming into contact with a part of the camera mount, and then move to a second side opposite to the first side, thereby overlapping the part when viewed from a central-axis direction of the accessory mount. An accessory having the above accessory mount also constitutes another aspect of the present disclosure. A camera mount attachable to the above accessory mount also constitutes another aspect of the present disclosure. An image pickup apparatus having the above camera mount also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a front view of a lens mount (accessory mount) according to a first embodiment.

FIG. 2 is a sectional view taken along line A-A of FIG. 1.

FIG. 3 is a partial side view of an interchangeable lens including the lens mount according to the first embodiment.

FIGS. 4A, 4B, and 4C are schematic diagrams illustrating processing of attaching the interchangeable lens of FIG. 3 to a camera body.

FIG. 5 is a front view of a lens mount according to a second embodiment.

FIGS. 6A, 6B, and 6C are sectional views taken along line B-B of FIG. 5, illustrating processing of attaching an interchangeable lens to a camera body.

FIG. 7 is a diagram illustrating a configuration of a camera system according to this embodiment.

FIG. 8 is a block diagram illustrating an electrical configuration of the camera system.

FIG. 9 is a diagram illustrating a variation of the lens mount according to the first embodiment.

### DESCRIPTION OF THE EMBODIMENTS

Referring now to the accompanying drawings, a detailed description will be given of embodiments according to the present disclosure.

### First Embodiment

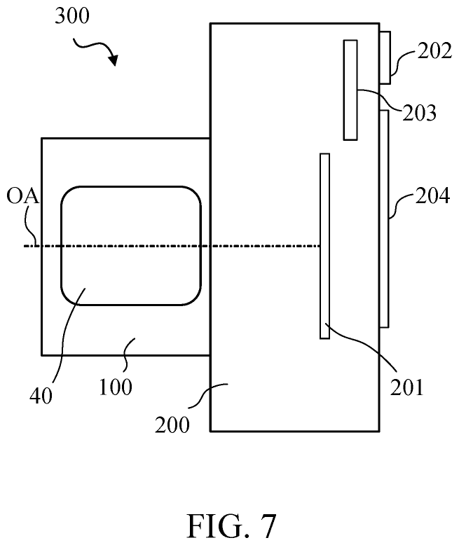

FIG. 7 illustrates a camera system including an interchangeable lens (lens apparatus) 100 as an accessory apparatus and a camera body 200 as an image pickup apparatus to which the interchangeable lens 100 is detachably attachable. The interchangeable lens 100 includes an imaging optical system (optical system, lens unit) 40. The imaging optical system 40 includes a plurality of lenses, such as a focus lens and a zoom lens, arranged on an optical axis OA, and an electromagnetic diaphragm.

The camera body 200 includes an image sensor 201, a viewfinder 202, a control unit 203, and a display unit 204. The image sensor 201 is a photoelectric conversion element such as a CCD sensor or a CMOS sensor, and generates image data by photoelectrically converting an optical image (object image) formed by the imaging optical system 40. The viewfinder 202 includes a display element that displays a finder image based on the image data and an eyepiece lens, and a user can observe the finder image displayed on the display element by looking through the eyepiece lens.

The control unit 203 includes a camera CPU and controls operations of the camera body 200. The display unit 204 is provided on a rear surface of the camera body 200, and displays a live-view image based on the image data or a captured image read from a recording medium (not illustrated). The display unit 204 includes a touch sensor that allows user operations for changing a variety of settings of the camera system.

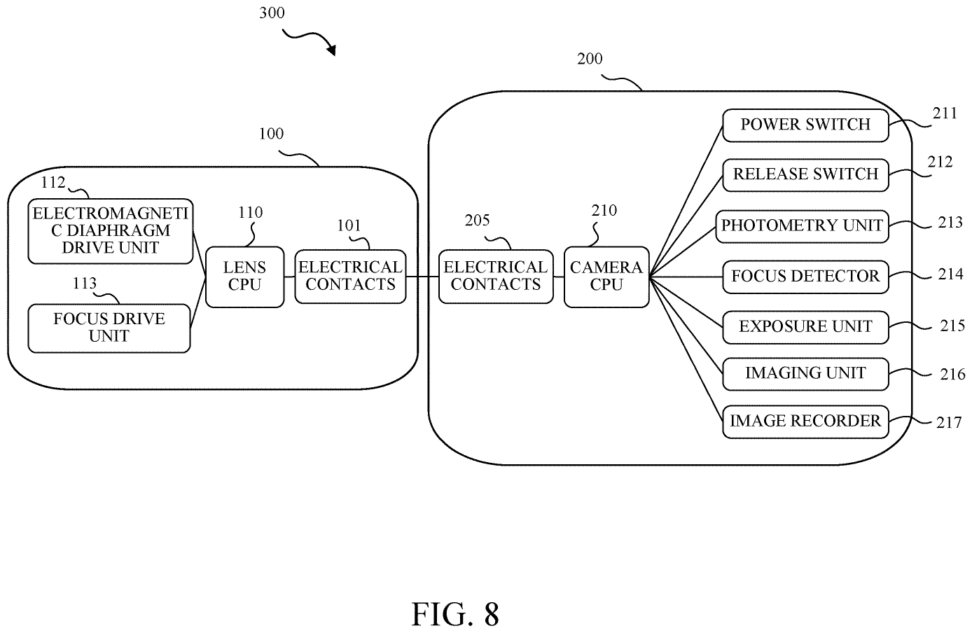

FIG. 8 illustrates the electrical configurations of the interchangeable lens 100 and the camera body 200. A camera CPU 210 is included in the control unit 203 described above and controls a variety of operations of the camera body 200. When the interchangeable lens 100 is attached, the camera CPU 210 communicates with a lens CPU 110 provided in the interchangeable lens 100 via electrical contacts 205 on the camera body side and electrical contacts 101 on the interchangeable lens side. The camera CPU 210 transmits information such as a drive amount of the focus lens and an aperture value of the electromagnetic diaphragm to the lens CPU 110. The lens CPU 110 transmits information such as an imaging magnification and other optical information to the camera CPU 210. The electrical contacts 101 and 205 include contacts for supplying power from the camera body 200 to the interchangeable lens 100.

The camera body 200 includes a power switch 211, a release switch 212, a photometry unit 213, a focus detector 214, an exposure unit 215, an imaging unit 216, and an image recorder 217. The power switch 211 is operable by a user to power on and off the camera body 200 and the interchangeable lens 100. The release switch 212 is operable by a user to instruct the camera CPU 210 to perform an imaging preparation operation and an imaging operation for recording. According to an SW1 signal input when the release switch 212 is half-pressed, the camera CPU 210 performs an imaging preparation operation including luminance measurement by the photometry unit 213, focus detection by the focus detector 214, and focus lens control. The camera CPU 210 determines an aperture value of the electromagnetic diaphragm and an exposure amount (shutter speed) of the image sensor 201 based on the photometry result. The camera CPU 210 also determines a drive amount of the focus lens for obtaining an in-focus state with respect to an object based on focus information on the imaging optical system 40 obtained by the focus detector 214. The camera CPU 210 transmits information on the determined aperture value and the drive amount of the focus lens to the lens CPU 110.

The interchangeable lens 100 includes, in addition to the lens CPU 110, an electromagnetic diaphragm drive unit 112 and a focus drive unit 113.

The lens CPU 110 controls the electromagnetic diaphragm to the aperture value received from the camera CPU 210 via the electromagnetic diaphragm drive unit 112, and drives the focus lens by the drive amount received from the camera CPU 210 via the focus drive unit 113.

The camera CPU 210 performs an imaging operation for recording according to an SW2 signal input when the release switch 212 is fully pressed. More specifically, the camera CPU 210 operates a shutter (not illustrated) included in the exposure unit 215 and causes the imaging unit 216 including the image sensor 201 to perform a photoelectric conversion operation.

Image data output from the imaging unit 216 (image sensor 201) is input to the camera CPU 210, and various image processing operations are performed by an image processing unit in the camera CPU 210. The image data after image processing is written to and stored in a recording medium such as a semiconductor memory, a magnetic disk, or an optical disc in the image recorder 217.

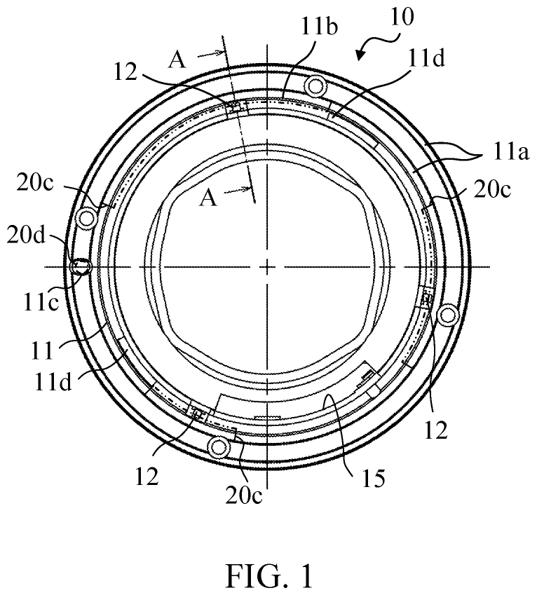

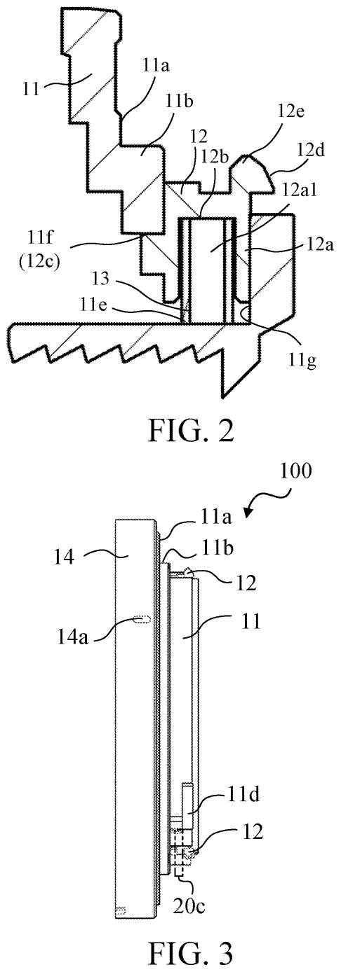

FIG. 1 illustrates a lens mount 10 as an accessory mount according to a first embodiment. The lens mount 10 is provided at an image-side end (camera body side) of the interchangeable lens 100, and is detachably attached (coupled) to a camera mount provided on an object side of the camera body 200. FIG. 2 illustrates a cross section taken along line A-A of the lens mount 10 illustrated in FIG. 1. FIG. 3 illustrates the lens mount 10 fixed to a lens barrel portion 14 of the interchangeable lens 100 when viewed from a direction orthogonal to a central axis (optical axis of the imaging optical system). A direction in which the central axis of the lens mount 10 extends is referred to as a central-axis direction, and a direction orthogonal to the central axis is referred to as a radial direction.

The lens mount 10 includes a ring-shaped (annular) mount base (base portion) 11 and engagement members 12 as movable portions (holder members) provided at a plurality of positions (three positions in this embodiment) in the circumferential direction around the central axis of the mount base 11.

The mount base 11 includes a lens mount surface 11a as an accessory mount surface configured to contact a mount surface of the camera mount (hereinafter referred to as a camera mount surface) in the central-axis direction, and a radial fitting portion 11b configured to radially fit with an inner circumferential surface of the camera mount. The mount base 11 further includes a lock hole portion 11c as a restriction portion (concave portion) that prevents rotation of the lens mount 10 relative to the camera mount in the circumferential direction, and claw portions 11d as projecting portions that project radially outward at a plurality of positions (two positions in this embodiment) in the circumferential direction. The lens mount may not include the lock hole portion and the claw portions.

As indicated by an alternate long and two short dashes line in FIG. 1, the camera mount includes a lock pin 20d as a convex portion that projects toward the lens mount 10 from the camera mount surface. While the lens mount surface 11a contacts the camera mount surface, the lock pin 20d enters the lock hole portion 11c and is engaged with the lock hole portion 11c in the circumferential direction, thereby preventing rotation of the lens mount 10 relative to the camera mount and fixing the position in the circumferential direction.

A contact holder 15 that holds the electrical contacts 101 illustrated in FIG. 8 is provided inside the mount base 11 of the lens mount 10.

As illustrated in FIG. 2, each engagement member 12 is held by the mount base 11 movably in the radial direction. More specifically, a base portion 12a as a part of the engagement member 12 is inserted into and held by a holding hole portion 11g formed in the mount base 11 so as to extend in the radial direction. An accommodation portion 12a1 is formed in the base portion 12a of the engagement member 12, and a compression coil spring (lens-side biasing member) 13 as an elastic member is accommodated in the accommodation portion 12a1.

One end of the compression coil spring 13 (a radially outer end of the mount base 11) contacts a bottom surface 12b of the accommodation portion 12a1, and the other end contacts a spring contact surface 11e of the mount base 11, whereby the compression coil spring 13 is compressed in the radial direction of the mount base 11. An elastic force (biasing force) generated by the compression coil spring 13 biases the engagement member 12 radially outward to a position at which a stopper portion 12c contacts a stopper portion 11f of the mount base 11 (referred to as an initial position hereinafter). The radially outward direction here is opposite to a direction in which the engagement member 12 retreats from a claw portion of a camera mount, as described later.

The engagement member 12 further includes an engagement portion (holder) 12e that projects radially outward from the base portion 12a. An image-side surface of the engagement portion 12e is formed as a tilted surface 12d that is tilted relative to a surface orthogonal to the central axis of the mount base 11.

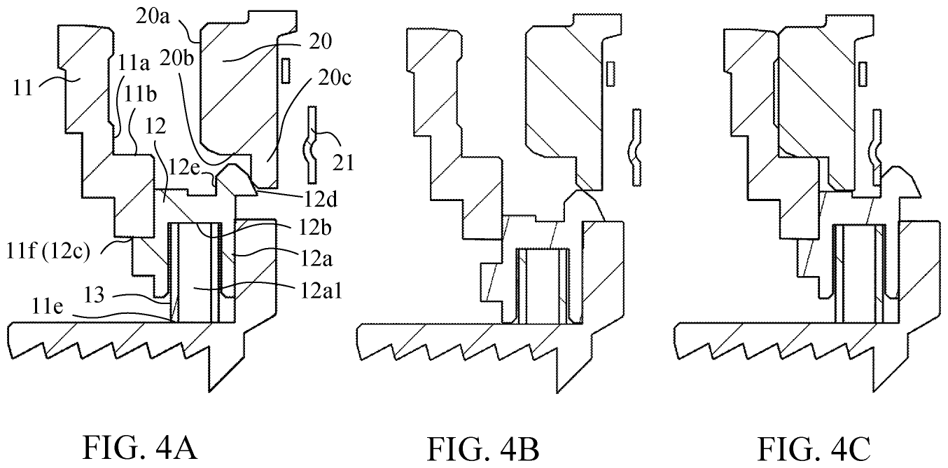

FIGS. 4A, 4B, and 4C illustrate a process of attaching the lens mount 10 to a camera mount 20. The camera mount 20 includes a camera mount surface 20a, a radial fitting portion 20b that radially fits with an outer circumferential surface of the radial fitting portion 11b of the lens mount 10, and a plurality (three in this embodiment) of claw portions 20c that project radially inward from the radial fitting portion 20b at a plurality of positions in the circumferential direction. The claw portions 20c of the camera mount 20 are bayonet claws that can be bayonet-coupled with claw portions provided on the lens mount 10 according to this embodiment and another accessory mount. A leaf spring (camera-side biasing member) 21 is disposed on an image side of each claw portion 20c as a part of the claw portion 20c. The claw portions 20c may have no leaf springs 21.

As illustrated in FIG. 3, a concave index 14a is provided on an outer circumferential surface of the lens barrel portion 14 of the interchangeable lens 100. An inner surface of the concave shape of the index 14a is colored differently from the outer circumferential surface of the lens barrel portion 14.

When attaching the lens mount 10 to the camera mount 20, first, a phase (rotational or angular position or orientation) of the lens mount 10 is aligned with a phase of the camera mount 20 so that a phase of the index 14a matches a phase of an index (not illustrated) provided on the camera body 200. In this phase, the lock pin 20d faces the lock hole portion 11c in the central-axis direction, and the electrical contacts 101 and 205 illustrated in FIG. 8 contact each other.

When the lens mount 10 is moved toward the camera mount 20 in the central-axis direction in this state, the claw portions 20c of the camera mount 20 come into contact with the tilted surfaces 12d of the engagement portions 12e of the engagement members 12 that are in the initial position (initial state), as illustrated in FIG. 4A.

When the lens mount 10 is further moved toward the camera mount 20 from the state of FIG. 4A, the claw portions 20c of the camera mount 20 press the tilted surfaces 12d in the central-axis direction, as illustrated in FIG. 4B. Thereby, the engagement members 12 move radially inward (a first side) from the initial position against the biasing force of the compression coil springs 13, and the engagement portions 12e retreat radially inward from the claw portions 20c.

When the lens mount 10 is further moved toward the camera mount 20 from the state of FIG. 4B, the claw portions 20c of the camera mount 20 ride over the engagement portions 12e of the engagement members 12, as illustrated in FIG. 4C. Thereby, the engagement members 12 move radially outward (a second side) by the biasing force of the compression coil springs 13 and return to the original initial positions illustrated in FIG. 4A, and the engagement portions 12e overlap the claw portions 20c axially on the side opposite the lens mount surface 11a. At the same time, the radial fitting portions 20b and 11b radially fit with each other, and the mount surfaces 20a and 11a contact each other. Further, when the engagement members 12 return to the initial positions, the engagement portions 12e contact the leaf springs 21 on the image side of the claw portions 20c, thereby compressing the leaf springs 21 between the engagement portions 12e and the claw portions 20c. As a result, the lens mount 10 is pulled toward the camera body side by the elastic force generated by the leaf springs 21.

In this manner, the state in which the mount surfaces 20a and 11a contact each other is maintained (separation of the mount surfaces 20a and 11a is prevented), and the position of the lens mount 10 relative to the camera mount 20 in the central-axis direction is fixed. As described above with reference to FIG. 1, the lock pin 20d enters the lock hole portion 11c, thereby fixing the position of the lens mount 10 relative to the camera mount 20 in the circumferential direction. Further, in this state, the electrical contacts 101 contact the electrical contacts 205, thereby enabling communication between the lens CPU 110 and the camera CPU 210.

Thus, the interchangeable lens 100 can be attached to the camera body 200 by aligning the phase of the index 14a of the interchangeable lens 100 with the phase of the index of the camera body 200 and pressing the lens mount 10 (interchangeable lens 100) toward the camera mount 20 (camera body 200) in the central-axis direction so that the mount surfaces 11a and 20a contact each other. That is, the interchangeable lens 100 can be attached to the camera body 200 without rotating the interchangeable lens 100 about the central axis relative to the camera body 200 while the mount surfaces 11a and 20a contact each other.

FIG. 1 illustrates the claw portions 20c of the camera mount 20 during the attachment of the interchangeable lens 100 to the camera body 200 by an alternate long and two short dashes line (phantom line or chain double-dashed line). During the attachment, the claw portions 11d of the lens mount 10 are circumferentially adjacent to the claw portions 20c of the camera mount 20. That is, the claw portions 11d function as guide portions (restriction portions that restrict circumferential movement) that guide movement in the central-axis direction by being circumferentially adjacent to (or in contact with) the claw portions 20c during attachment.

During the attachment and before the lock pin 20d enters the lock hole portion 11c (before the mount surfaces 11a and 20a contact each other as illustrated in FIG. 4C), the claw portions 11d overlap the claw portions 20c in the central-axis direction. Properly setting the relationship between the claw portions 11d and the claw portions 20c in this manner can provisionally determines the position of the interchangeable lens 100 during the attachment to the camera body 200. As a result, the lock pin 20d can be easily engaged with the lock hole portion 11c.

When detaching the lens mount 10 from the camera mount 20, the user operates a lock release button (not illustrated) provided on the camera body 200, thereby moving the lock pin 20d toward the camera body side and retracting the lock pin 20d from the lock hole portion 11c. Then, by rotating the interchangeable lens 100 relative to the camera body 200 to a position where the engagement members 12 are out of phase with the claw portions 20c of the camera mount 20, the lens mount 10 can be detached from the camera mount 20.

An operation mechanism may be provided in the interchangeable lens 100 to retract the engagement members 12 from the initial position according to a user operation on an operation member (operation unit). This configuration can remove the lens mount 10 from the camera mount 20 without rotating the interchangeable lens 100 relative to the camera body 200.

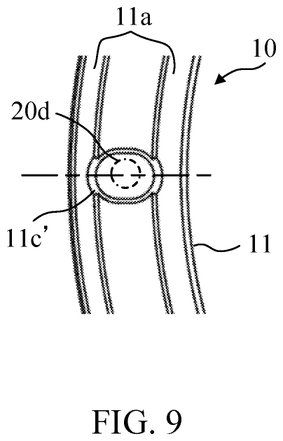

In this embodiment, the lens mount 10 (mount base 11) includes the lock hole portion 11c that is engaged with the lock pin 20d in the circumferential direction while the mount surfaces 11a and 20a contact each other. However, as illustrated in FIG. 9, the lens mount 10 (mount base 11) may include a concave non-contact portion 11c′ that retreats from the lock pin 20d in the circumferential direction (and also in the radial direction and further in the central-axis direction) while the mount surfaces 11a and 20a contact each other. In this case, the interchangeable lens 100 may include a rotation lock mechanism that prevents circumferential rotation of the lens mount 10 relative to the camera mount 20 while the mount surfaces 11a and 20a contact each other. However, when the camera system is used while being supported by a support member such as a tripod, the rotation lock mechanism may be omitted.

The non-contact portion 11c′ is not limited to a concave shape, and may have a shape in which a part of the mount base 11 in the radial direction or the circumferential direction is removed.

### Second Embodiment

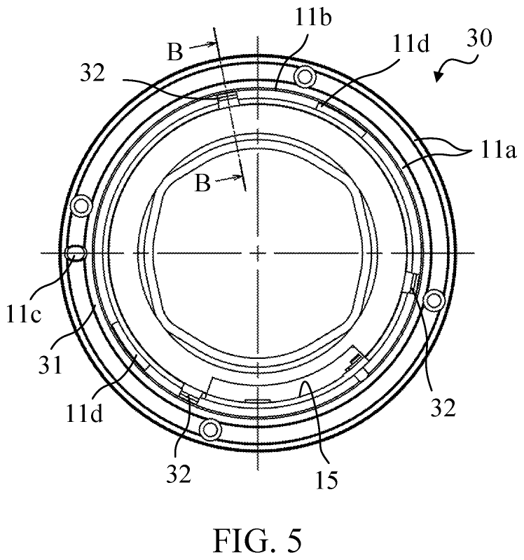

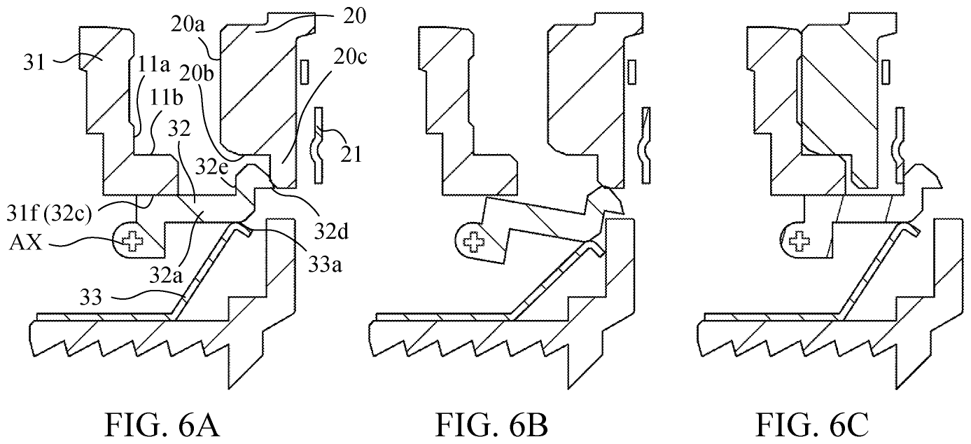

FIG. 5 illustrates a lens mount 30 as an accessory mount according to a second embodiment. Those elements in the lens mount 30 according to this embodiment, which are common to the lens mount 10 according to the first embodiment, will be designated by the same reference numerals as those in the first embodiment, and a description thereof will be omitted. FIGS. 6A, 6B, and 6C illustrate, in a cross section taken along line B-B of the lens mount 30 illustrated in FIG. 5, a process of attaching the lens mount 30 to the camera mount 20.

The lens mount 30 includes a mount base 31 and engagement members 32 as holder members provided at a plurality of positions (three positions in this embodiment) of the mount base 31 in the circumferential direction. The mount base 31 includes, similarly to the first embodiment, the lens mount surface 11a, the radial fitting portion 11b, the lock hole portion 11c, and the claw portions 11d at two positions in the circumferential direction. A contact holder 15 that holds the electrical contacts 101 is provided inside the mount base 31, similarly to the first embodiment.

In this embodiment, as illustrated in FIGS. 6A, 6B, and 6C, each engagement member 32 is held by the mount base 31 rotatably (movably) about an axis AX.

More specifically, a leaf spring 33 as an elastic member is fixed to the mount base 31, and the leaf spring 33 has a contact surface 33a at its tip that contacts the engagement member 32, thereby biasing the engagement member 32 counterclockwise from the rotational position of FIG. 6B toward the rotational position of FIG. 6A. The counterclockwise direction here is opposite to a direction in which the engagement member 32 retreats from the claw portions 20c of the camera mount 20, as described later.

In the state of FIG. 6A, a contact surface 32c provided on a base portion 32a of the engagement member 32 contacts a contact surface 31f of the mount base 31, thereby preventing further counterclockwise rotation of the engagement member 32 and holding the engagement member 32 at the initial position (initial state).

The engagement member 32 includes an engagement portion 32e that projects radially outward beyond the base portion 32a. An image-side surface of the engagement portion 32e is formed as a tilted surface 32d that is tilted relative to a surface orthogonal to the central axis of the mount base 31.

When attaching the lens mount 30 to the camera mount 20, first, similarly to the first embodiment, the phase of the lens mount 30 is aligned with the phase of the camera mount 20 so that a phase of the index 14a matches a phase of an index of the camera body 200. When the lens mount 30 is moved toward the camera mount 20 in the central-axis direction in this state, the claw portions 20c of the camera mount 20 come into contact with the tilted surfaces 32d of the engagement portions 32e of the engagement members 32, as illustrated in FIG. 6A.

When the lens mount 30 is further moved toward the camera mount 20 from the state of FIG. 6A, the claw portions 20c of the camera mount 20 press the tilted surfaces 32d in the central-axis direction, as illustrated in FIG. 6B. As a result, the engagement members 32 rotate (move) clockwise about the axis AX from the initial positions against the biasing force of the leaf springs 33 so that the engagement portions 32e retreat radially inward of the lens mount 30.

When the lens mount 30 is further moved toward the camera mount 20 from the state of FIG. 6B, the claw portions 20c of the camera mount 20 ride over the engagement portions 32e of the engagement members 32, as illustrated in FIG. 6C. Thereby, the engagement members 32 rotate counterclockwise by the biasing force of the leaf springs 33 so as to return to the original initial positions, and the engagement portions 32e overlap the claw portions 20c axially on the side opposite the lens mount surface 11a (when viewed from the central-axis direction). At the same time, the radial fitting portions 20b and 11b radially fit with each other, and the mount surfaces 20a and 11a contact each other. The leaf springs 21 of the camera mount 20 are compressed between the engagement portions 32e of the engagement members 32 that have returned to the initial positions and the claw portions 20c, and the lens mount 30 is pulled toward the camera mount side by the elastic force generated by the leaf springs 21.

In this manner, the state in which the mount surfaces 20a and 11a contact each other is maintained, and the position of the lens mount 30 relative to the camera mount 20 in the central-axis direction is fixed. As described in the first embodiment with reference to FIG. 1, the lock pin 20d enters the lock hole portion 11c, thereby fixing the position of the lens mount 30 relative to the camera mount 20 in the circumferential direction. Further, in this state, the electrical contacts 101 described in the first embodiment with reference to FIG. 8 contact the electrical contacts 205, thereby enabling communication between the lens CPU 110 and the camera CPU 210.

As described above, the interchangeable lens can be attached to the camera body by aligning the phase of the index 14a of the interchangeable lens 100 with the phase of the index of the camera body 200 and pressing the lens mount 30 (interchangeable lens) toward the camera mount 20 (camera body) in the central-axis direction so that the mount surfaces 11a and 20a contact each other. That is, the interchangeable lens can be attached to the camera body without rotating the interchangeable lens about the central axis relative to the camera body while the mount surfaces 11a and 20a contact each other.

Each of the embodiments described above enables the interchangeable lens as an accessory apparatus to be attached more easily than the conventional method that requires rotating the interchangeable lens relative to the camera body as an image pickup apparatus.

In each of the embodiments, the accessory mount includes an accessory mount surface that contacts a camera mount surface provided on the camera mount in the central-axis direction, and a holder member. The holder member retreats from the camera mount when being pressed by the camera mount, and then returns to the overlapping state when viewed from the central-axis direction relative to the camera mount, thereby maintaining the state in which the accessory mount surface contacts the camera mount surface.

In the first and second embodiments, the engagement members 12 and 32 are biased by the springs 13 and 33 against the mount bases 11 and 31. Alternatively, the engagement members may be formed of members whose engagement portions can elastically deform, and the engagement portions pressed by the claw portions of the camera mount may elastically deform to move (retreat) relative to the claw portions. This structure can eliminate the springs 13 and 33. The elastically deformable engagement portions may be integrated with the base portion serving as the mount base. Instead of the engagement members that are movable in the radial direction of the mount base, the engagement members may be movable in the circumferential direction of the mount base.

The configuration of the lens mount described in each embodiment may also be applied to an accessory mount provided on an accessory apparatus other than an interchangeable lens, which is attachable to and detachable from the camera body. Examples of such an accessory apparatus include an adapter (intermediate adapter) attachable and detachable between the camera and the lens apparatus, an extender, and a cap for protecting a camera mount. The adapter may have a function of converting a communication method between the camera and the lens apparatus, or may include an optical element such as a lens or an optical filter.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide an accessory mount that can be easily attached to a camera mount.

This application claims the benefit of Japanese Patent Application No. 2025-072941, filed on Apr. 25, 2025, which is hereby incorporated by reference herein in its entirety.

What is claimed is:

1. An accessory mount attachable to and detachable from a camera mount, the accessory mount comprising:
a base portion; and
a movable portion movable relative to the base portion,
wherein, when the accessory mount is attached to the camera mount, the movable portion moves to a first side by coming into contact with a part of the camera mount, and then moves to a second side opposite to the first side, thereby overlapping the part when viewed from a central-axis direction of the accessory mount.

2. The accessory mount according to claim 1, wherein the first side and the second side are one side and the other side, respectively, in a radial direction of the base portion.

3. The accessory mount according to claim 1, wherein the base portion includes an accessory mount surface that contacts a camera mount surface of the camera mount while the accessory mount is attached to the camera mount.

4. The accessory mount according to claim 3, wherein the movable portion overlaps the part when viewed from the central-axis direction while the accessory mount is attached to the camera mount, thereby maintaining a state in which the accessory mount surface contacts the camera mount surface.

5. The accessory mount according to claim 1, wherein the part includes a claw portion provided on the camera mount.

6. The accessory mount according to claim 1, further comprising a biasing unit configured to bias the movable portion toward the second side.

7. The accessory mount according to claim 6, wherein, when the accessory mount is attached to the camera mount, the movable portion moves toward the first side against a biasing force of the biasing unit by coming into contact with the part of the camera mount.

8. The accessory mount according to claim 1, wherein the accessory mount is attached to the camera mount by moving toward the camera mount in the central-axis direction without rotating about a central axis.

9. The accessory mount according to claim 1, wherein each of the camera mount and the accessory mount includes electrical contacts, and
wherein corresponding electrical contacts of the camera mount and the accessory mount contact each other without contacting other electrical contacts when the accessory mount is attached to the camera mount.

10. The accessory mount according to claim 1, further comprising an operation mechanism configured to move the movable portion according to a user operation.

11. The accessory mount according to claim 1, wherein the base portion includes a guide portion configured to guide movement in the central-axis direction by the part when the accessory mount is attached to the camera mount.

12. The accessory mount according to claim 11, wherein the guide portion is disposed, in the central-axis direction, on a side opposite to an accessory mount surface provided on the accessory mount with respect to the claw portion while the accessory mount is attached to the camera mount.

13. An accessory apparatus comprising:
the accessory mount according to claim 1; and
an optical element.

14. An accessory apparatus comprising:
the accessory mount according to claim 1,
wherein the accessory apparatus is attachable to and detachable from a lens apparatus.

15. A camera mount comprising:
a claw portion including the part,
wherein the camera mount is attachable to and detachable from the accessory mount according to claim 1.

16. An image pickup apparatus comprising:
the camera mount according to claim 15; and
an image sensor.
